(19) United States
(12) Patent Application Publication
(10) Pub. No.: US 2011/0209365 A1
(43) Pub. Date: Sep. 1, 2011

(54) GREETING CARDS WITH MUSIC AND MULTIMEDIA CONTENT AND LINKS

(76) Inventors: Allison Marsh, Ravenna, OH (US); Carol Miller, Twinsburg, OH (US)

(21) Appl. No.: 13/038,204

(22) Filed: Mar. 1, 2011

Related U.S. Application Data
(60) Provisional application No. 61/309,188, filed on Mar. 1, 2010.

(51) Int. Cl. G09F 1/00; B42D 15/00

(52) U.S. Cl. 40/124.03; 283/100

(57) ABSTRACT

Digital media greeting cards with self-contained sound, image, light or other electronic modules operative to play digital media, and related digital media either packaged with the greeting car or accessible via an internet link which is identified or enabled by the greeting card. Audio digital media cards contain a digital sound producing module and hold a CD or other digital media device with corresponding digital media content to that of the sound module, or a link to an internet site where corresponding digital media content is located. The sound module contains a sampling of the music contained on the audio CD so that a consumer can sample the CD before deciding to purchase the greeting card or so that the greeting card recipient is provided with a sample of what is contained on the CD. In an alternate embodiment, the greeting card contains an alphanumeric code printed thereon that will allow the recipient to download one or more audio files from an internet based digital music provider. The sound module contains a sampling of the music available form an internet digital music provider or may contain instructions for downloading or a simple spoken greeting or instruction. The sound module may be activated by manipulation of the card or by mechanical means, a light sensor, a magnetic sensor or an air pressure sensor incorporated in the card. Alternate embodiments of greeting cards of the disclosure employ video image and sound modules, and bear printed indicia which is operatively interactive with an imaging device and a computer whereby the printed indicia of the greeting card initiates a link to digital media via the computer.

### RELATED APPLICATIONS

This application claims priority to U.S. Provisional Patent Application No. 61/309,188 filed on Mar. 1, 2010, which is incorporated herein in its entirety.

This application is related to U.S. patent application Ser. No. 12/407,090, filed on Mar. 19, 2009, which is incorporated herein in its entirety.

### FIELD OF THE INVENTION

The present disclosure and related inventions pertain to greeting cards and more specifically to greeting cards with enclosed or linked music media or multimedia and previews of the media contents.

### BACKGROUND OF THE INVENTION

Social expression products such as greeting cards are increasingly provided with sound media. Sound in greeting cards is used in a variety of ways. Some greeting cards contain pre-recorded sounds or messages or greetings activated upon the opening of the greeting card. A pre-recorded message may contain music, singing, a spoken greeting or even a celebrity voiced greeting. Other greeting cards provide the user with the ability to record their own personalized message to be played back upon opening the greeting card or by some other activation method. With the ever increasing prevalence of digital media and growing use of the internet and social networking, conventional social expression products such as paper greeting cards can seem antiquated and without connection to the wide array and availability of digital media.

### SUMMARY OF THE INVENTION

A greeting card with music media having a multi-panel greeting card body, a sound module concealed within the panels of the greeting card body, at least one digital audio file saved within the sound module, a switch designed to initiate playback of the at least one digital audio file saved within the sound module and at least one digital data storage device attached to the multi-panel greeting card body, the at least one digital data storage device having at least one digital audio file contained thereon. The at least one digital audio file saved within the sound module contains a preview or shortened version of the at least one digital audio file contained on the at least one digital data storage device.

In another embodiment, the greeting card with music media contains a greeting card body having a first panel attached to a second panel along a first fold line and a third panel attached to the second panel along a second fold line, a sound module comprising a circuit board, an integrated circuit, a microprocessor, a data storage device, a speaker and at least one digital audio file contained on the data storage device, the sound module concealed between the second and third panels of the greeting card, a slide switch located across the first fold line operative to initiate playback of the at least one digital audio file upon opening of the greeting card, and a CD attached to the first or third panel of the greeting card, the CD containing at least one digital audio file. The at least one digital audio file contained on the data storage device of the sound module is a preview of the at least on e digital audio file contained on the CD.

In still another embodiment, the greeting card with music media includes a multi-panel greeting card body, a sound module attached to the greeting card body, the sound module having at least one digital audio file contained thereon, a mechanical switch operative to initiate playback of the at least one digital audio file, and a URL printed on the greeting card body, the URL containing the address of at least one digital audio file available for downloading.

### DESCRIPTION OF THE DRAWINGS

FIG. 1 is a perspective view of a first embodiment of the greeting card of the present invention, in a closed position.

FIG. 2 is a perspective view of the greeting card of FIG. 1, in a fully open position.

FIG. 3 is a perspective view of a second embodiment of the greeting card of the present invention.

### DETAILED DESCRIPTION OF PREFERRED AND ALTERNATE EMBODIMENTS

The greeting card with music and/or multi-media of the present disclosure and related inventions, indicated generally in the figures as reference numeral 10, combines a traditional greeting card (for example a paper form card in any configuration of one or more interconnected pages or panels), with a sound module or multimedia module in the form of a small digital circuit 24 with battery power 26 and a speaker 28 and digital media content which is activated and played, for example, by manipulation of the card 10 which operates a switch 18, and a media device such as a CD or DVD otherwise attached to or other wise combined with or linked to the card 10. The sound module may contain, for example, a clip or sampling of music from the media contained or packaged within the greeting card. For example, if the greeting card 10 contains a compact disc (CD) 20 or other digital media, then the sound module would contain a clip or sampling of the music contained on the CD 20. If the greeting card does not contain a CD 20 or other media, there may be a link (URL) or internet website address 22 where digital media content which corresponds to the sound clip is located. For example, the sound clip contained on the sound module may be a sample of a particular song, and the entire song (or entire album in which the song is included) is either on the accompanying CD 20 or at the internet address location 22 which is printed on the card 10.

A representative greeting card, shown in FIG. 2, contains a first panel 12 attached to a second panel 14 along a first fold line A and a third panel 16 connected to the second panel 14 along a second fold line B. Each greeting card panel 10, 12, 14 contains a front side and a back side. A mechanically activated sound module is attached to the front side 14a of the second panel 14 and the third panel 16 is folded along the second fold line B between the second 14 and third 16 panels and attached, adhesively or otherwise, to the second panel 14 along the first fold line A between the first 12 and second 14 panels so as to conceal the sound modules between the second 14 and third 16 panels of the greeting card 10. The back side 12b of the first panel 12 becomes the front face of the greeting card 10 and may contain text sentiment and/or artwork. The inside of the greeting card 10, which consists of the front side 12a of the first panel 12 as the left inside panel and the back side 16b of the third panel 16 as the right inside panel, many contain further text sentiment and/or artwork. A mechanical switch 18, also sometimes referred to as a “slide switch', extends across the first fold line A between the first 12 and second 14 panels of the greeting card 10. When a user opens the greeting card 10 by unfolding the first panel 12 along the first fold line A between the first 12 and second 14 panels, the electrical circuit is closed, thereby activating the sound module to play the music clip contained thereon. Other types of switches or circuit activation devices may be used in connection with the sound and/or image generating circuitry of the card, such as for example, capacitive switches, light sensing switches, pressure switches (piezoelectric), or magnetic contact switches. The greeting card body 10 may be made of paper, cardboard, paperboard, or any other suitable material that would be strong enough to hold an attached digital storage device.

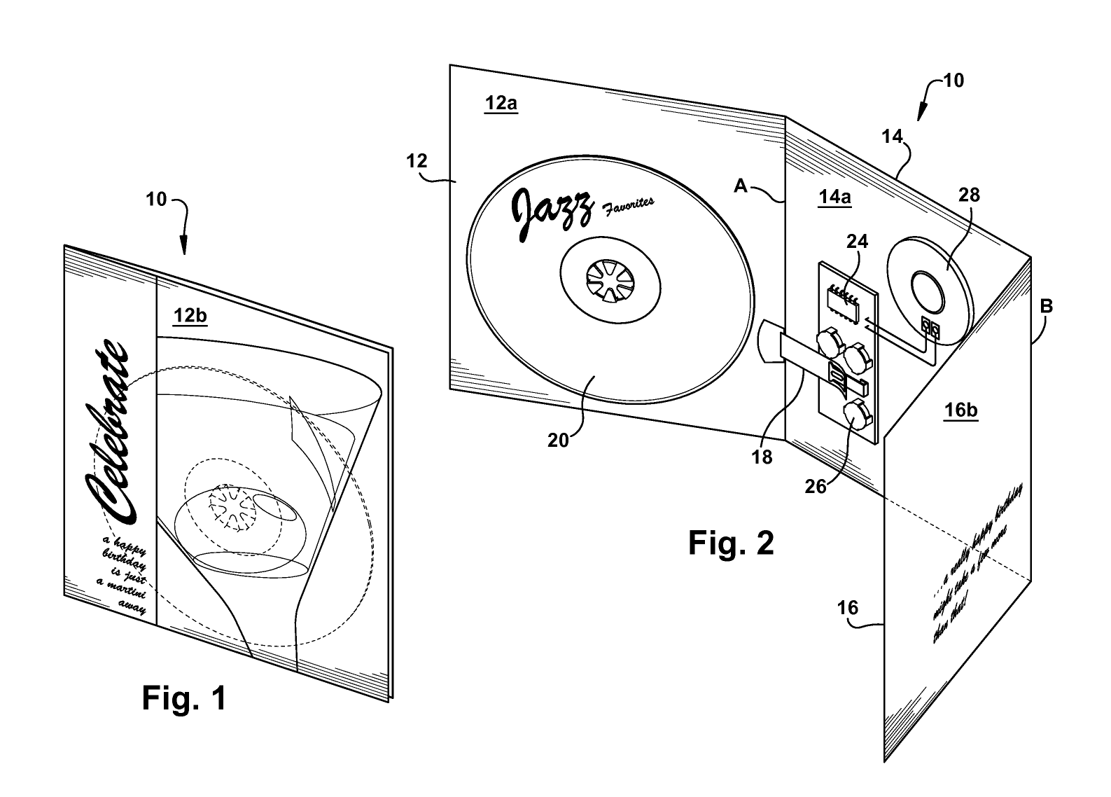

In one embodiment, a CD 20 is attached, adhesively or otherwise to the left inside panel 12a of the greeting card 10. The music clip contained on the sound module is a sampling or preview of the music contained on the CD 20. This allows a potential purchaser to preview the audio CD 20 (which may be packaged with the card, or held in a pocket or secured to one of the panels of the card) before deciding to purchase the card. It also gives the recipient a sampling of the music contained on the CD 20. Additionally, the text sentiment and/or artwork contained on the front and/or inside panels 12a, 16b of the greeting card 10 may have the same theme or be complimentary to the music contained on the CD 20. For example, in the embodiment shown in FIGS. 1 and 2, the front 12b of the greeting card 10 contains a picture of a martini with associated text sentiment on both the front 12b and inside 12a, 16b of the greeting card 10 and the CD 20 contains “jazz favorites”. The CD 20 may alternatively contain an audio book, wherein a sampling or short introduction to the book is contained within the sound module of the greeting card. As noted, in place of or in addition to one or more CDs, any other type of digital media device, such as a zip drive, SD or “smart” card or chip may be combined with the greeting card which may also contain information such as an internet address having the same, additional, or related digital media content.

In another embodiment, instead of a CD, a DVD is attached to the greeting card. The DVD may contain digital video and audio content such as a video or movie. In this case, the digital audio clip contained within the sound module of the greeting card may contain a song from the movie contained on the DVD or a sampling of dialogue or an audio trailer from the movie.

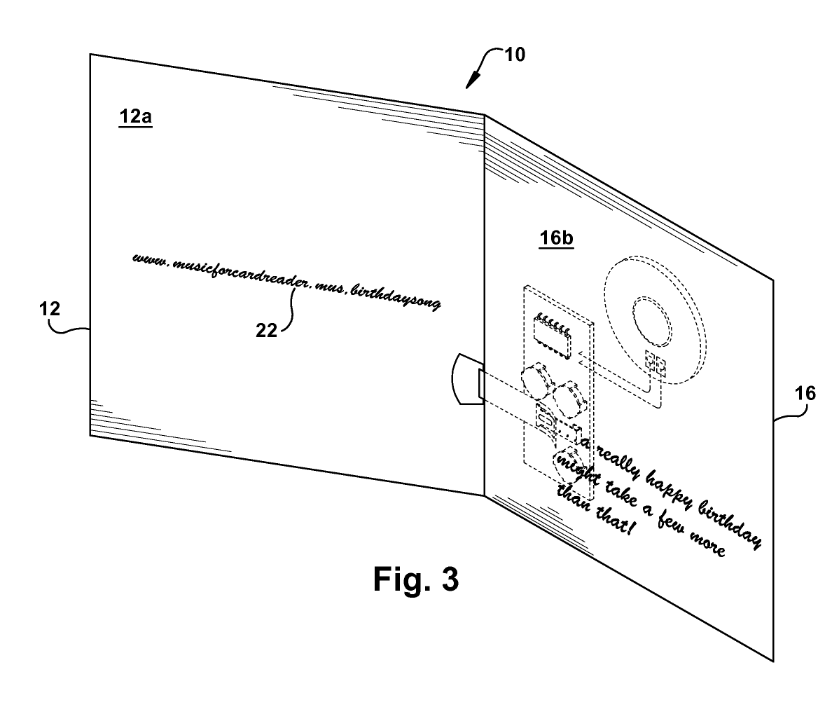

In still another embodiment, shown in FIG. 3, in place of a CD or DVD, the greeting card 10 contains a code or series of alphanumeric characters, or internet address, i.e., URL address 22, which lead to the location of digital media content, for example to download one or more songs in MP3 or other digital music format including but not limited to: WAV; WMA (Windows Media Audio); Real Audio (.ra, .ram, .rm); MIDI (Musical Instrument Digital Interface); and Ogg (.ogg) file formats from an internet based digital music service provider. Examples of such services include Apple iTunes©, Amazon MP3©, Napster©, and Rhapsody©. In this embodiment, the greeting card 10 may again be a multiple panel greeting card having a mechanically activated sound module containing a short audio clip that is triggered by a user opening the greeting card 10. The card 10 may contain text, sentiment or message and/or artwork on the front 12b and inside 12a, 16b panels of the greeting card 10, and the code or password 22 used to retrieve a full audio file. The code 22 may appear anywhere on the greeting card and may be concealed until the actual purchase or receipt of the greeting card. The code 22 may be concealed by a substance requiring the user to scratch off the substance to reveal the code underneath or the code 22 may be concealed beneath a removable sticker, perforated tab or by other suitable concealment means. The card 10 may also contain instructions for the user to follow in order to download an audio file using the code 22 provided within the greeting card 10. The code 22 may allow the recipient to download one or more specific digital music files or it may allow the recipient to download one or more digital music files of the users choice. The sound clip which is activated upon opening the greeting card 10 may contain a sampling of the specific song or songs retrievable with the attached code 22 or may simply contain a sampling of music available to the recipient for downloading. Alternatively, the sound clip may contain instructions on using the code 22 to download an audio file or files or it may simply contain a spoken greeting.

In yet another embodiment, the printed indicia or other information on the greeting card is configured to interact with and be recognized by a digital device such as an imaging device such as a webcam, a camera operatively connected to a computer which is connected to the internet. Greeting cards of the present disclosure may bear printed indicia which is operatively interactive with an imaging device and a computer, whereby the printed indicia of the greeting card initiates a link to digital media via a computer. Recognition of the printed indicia or information on the greeting card by the webcam can be used to prompt the computer to go to a particular internet address where corresponding digital content resides. This may be referred to as a form of “augmented reality” wherein the tangible card in the user's hands is combined with digital content on the internet. Augmented reality (AR) is a term for a live direct or indirect view of a physical real-world environment whose elements are merged with (or augmented by) virtual computer generated imagery, thereby creating a mixed or augmented reality. Augmentation may be in real-time and in semantic context with environmental elements, such as sports scores on TV during a match. With the help of advanced AR technology, such as computer vision and object recognition, the information about the surrounding real world of the user becomes interactive and digitally usable. Artificial information about the environment and the objects in it can be stored and retrieved as an information layer on top of the real world view. Any of the various embodiments of the described greeting cards, whether with sound, light image, video capabilities can also be configured with an augmented reality link and further in combination with a URL link to related digital content.

In addition to the mechanically activated sound module having a switch 18 contained across a fold line of the greeting card, as noted the sound and/or image generating module or circuitry may be activated using other activation methods such as optical activation, magnetic activation and air pressure activation. Also, instead of automatic activation upon the opening of the greeting card, the sound module may be activated using a mechanical push button switch that the user must press to activate the sound clip.

Although the invention has be described as a three panel greeting card with a sound module concealed between two panels, the greeting card may contain any number of panels and/or concealment mechanisms. The descriptions contained herein are provided as sample embodiments but are not in any way intended to limit the scope of the invention. One who is skilled in the art can imagine the greeting card and sound module having many different design structures without departing from the spirit of the invention. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A greeting card with music media comprising:
a multi-panel greeting card body;
a sound module concealed within the panels of the greeting card body;
at least one digital audio file saved within the sound module;
a switch designed to initiate playback of the at least one digital audio file saved within the sound module; and
at least one digital data storage device attached to the multi-panel greeting card body, the at least one digital data storage device having at least one digital audio file contained thereon,
wherein the at least one digital audio file saved within the sound module contains a preview or shortened version of the at least one digital audio file contained on the at least one digital data storage device.

2. The greeting card with music media of claim 1, wherein the at least one digital data storage device is a CD.

3. The greeting card with music media of claim 1, wherein the at least one digital data storage device is a DVD.

4. The greeting card with music media of claim 1, wherein the at least one digital data storage device is an SD card.

5. The greeting card with music media of claim 1, wherein the at least one digital data storage device is a zip drive.

6. The greeting card with music media of claim 1, wherein the switch is a slide switch which is triggered upon opening the greeting card.

7. The greeting card with music media of claim 1 further comprising printed indicia which is operatively interactive with an imaging device and a computer whereby the printed indicia initiates a link to digital media via the computer.

8. A greeting card with music media comprising:
a greeting card body having a first panel attached to a second panel along a first fold line and a third panel attached to the second panel along a second fold line;
a sound module comprising a circuit board, an integrated circuit, a microprocessor, a data storage device, a speaker and at least one digital audio file contained on the data storage device, the sound module concealed between the second and third panels of the greeting card;
a slide switch located across the first fold line operative to initiate playback of the at least one digital audio file upon opening of the greeting card; and
a CD attached to the first or third panel of the greeting card, the CD containing at least one digital audio file,
wherein the at least one digital audio file contained on the data storage device of the sound module is a preview of the at least one digital audio file contained on the CD.

9. The greeting card with music media of claim 8, wherein the at least one digital audio file contained on the CD contains an audio book.

10. The greeting card with music media of claim 8, wherein the at least one digital audio file contained on the CD contains music.

11. The greeting card with music media of claim 8 further comprising printed indicia which is operatively interactive with an imaging device and a computer whereby the printed indicia initiates a link to digital media via the computer.

12. A greeting card with music media comprising:
a multi-panel greeting card body;
a sound module attached to the greeting card body, the sound module having at least one digital audio file contained thereon;
a mechanical switch operative to initiate playback of the at least one digital audio file; and
a URL printed on the greeting card body, the URL containing the address of at least one digital audio file available for downloading.

13. The greeting card with music media of claim 12, wherein the at least one digital audio file contained on the sound module is a preview of the at least one digital audio file available for downloading.

14. The greeting card with music media of claim 12, wherein the at least one digital audio file contained on the sound module contains spoken instructions on how to download the at least one digital audio file available for downloading.

15. The greeting card with music media of claim 12, wherein the at least one digital audio file available for downloading is selected by the greeting card recipient.

16. The greeting card with music media of claim 12, wherein the digital audio file available for downloading is an MP3 file.

17. The greeting card with music media of claim 12, wherein the URL is the address of a website of an online digital music provider.

18. The greeting card with music media of claim 12, wherein the URL is concealed by a scratch off substance.

19. The greeting card with music media of claim 12 further comprising instructions for downloading an audio file printed on the greeting card body.

20. The greeting card with music media of claim 12 further comprising printed indicia which is operatively interactive with an imaging device and a computer whereby the printed indicia initiates a link to digital media via the computer.
